(19) United States
(12) Patent Application Publication
(10) Pub. No.: US 2021/0407123 A1
(43) Pub. Date: Dec. 30, 2021

(54) THREE-DIMENSIONAL CALIBRATION TARGET

(71) Applicant: Hewlett-Packard Development Company, L.P., Spring, TX (US)

(72) Inventors: Yun D. TANG, San Diego, CA (US); Matthew G. LOPEZ, San Diego, CA (US); Vijaykumar NAYAK, San Diego, CA (US); Andy Y. LIAO, San Diego, CA (US); Javier A. URQUIZU, San Diego, CA (US)

(21) Appl. No.: 16/481,250

(22) PCT Filed: Apr. 19, 2018
(86) PCT No.: PCT/US18/28447

§ 371 Date: Jul. 26, 2019

(51) Int. Cl. G06T 7/73; G06T 17/00; G06T 7/80

(52) U.S. Cl. CPC G06T 7/73; G06T 17/00; G06T 2207/10028; G06T 2207/30244; G06T 7/80

(57) ABSTRACT

A three-dimensional calibration target may include an asymmetric polyhedron having a bottom and at least four faces, a base platform underlying the bottom and rotatably supporting the asymmetric polyhedron and a home position indicator to indicate a predefined angular position of the asymmetric polyhedron relative to the base.

### BACKGROUND

Three-dimensional scanning systems are used to collect data regarding the shape of real-world objects. Such data may then be utilized to construct digital three-dimensional models. Many three-dimensional scanning systems employ multiple cameras positioned about the real-world object for which data is being collected.

### BRIEF DESCRIPTION OF THE DRAWINGS

FIG. 1 is a schematic diagram illustrating portions of an example calibration target.

FIG. 2 is a top view of the example calibration target of FIG. 1 in a first angular position.

FIG. 3 is a top view of the example calibration target of FIG. 1 in a second angular position.

FIG. 4A is a schematic diagram illustrating portions of an example three-dimensional scanning system.

FIG. 4B is a schematic diagram illustrate portions of an example three-dimensional scanning system.

FIG. 4C is a schematic diagram illustrating portions of an example three-dimensional scanning system.

FIG. 5 is a flow diagram of an example three-dimensional multi-camera calibration method.

FIG. 6 is a schematic diagram illustrating portions of an example scanning system.

FIG. 7 is a top view of an example calibration target.

FIG. 8 is a bottom view of the example calibration target of FIG. 7.

FIG. 9 is a sectional view of the example calibration target of FIG. 8 taken along line 9-9.

FIG. 10 is a bottom perspective view of an example calibration target.

FIG. 11 is a sectional view of the example calibration target of FIG. 10.

FIG. 12 is a flow diagram of an example three-dimensional multi-camera calibration method.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are three-dimensional calibration targets, methods and three-dimensional scanning systems that facilitate more reliable and less complex calibration of multiple cameras. The disclosed three-dimensional calibration targets, methods and three-dimensional scanning systems are multipurpose in that they facilitate calibration, calibration verification and scan quality validation.

Disclosed herein are three-dimensional calibration targets methods and three-dimensional scanning systems that utilize a single integrated calibration target having a precise and repeatable rotational mechanism. The three-dimensional calibration target has an asymmetrical multi-surface geometry of at least four surfaces to facilitate detection calibration. In some implementations, an additional top surface is provided which facilitates white point reference/correction in a chosen color space and as a reference plane for three-dimensional calibration.

In some example implementations, each of the at least four faces has an angle of at least 30° and no greater than 70° with respect to the horizontal with an angle resolution for separation of at least 5°. Each face may be provided with a unique color code with a design maximum contrast to separate each surface in any given color space. In those implementations having a top surface, the top surface may be light gray for auto-white balance.

In some implementations, the example calibration target provides precise and repeatable rotation, wherein three-dimensional coordinates of all corners are defined for 2-D to 3-D correspondence when the calibration target moves to a particular angle, wherein multiple angles are merged to one pose for full camera calibration. The calibration target may be implemented for RGB to depth stereo calibration as well as for stereo validation between RGB and depth camera. Calibration with the calibration target solves multiple depth correspondence through the partial target scan and scan alignment to the full 3-D model from each depth camera.

Disclosed is an example three-dimensional calibration target that may include an asymmetric polyhedron having a bottom and at least four faces, a base platform underlying the bottom and rotatably supporting the asymmetric polyhedron and a home position indicator to indicate a predefined angular position of the asymmetric polyhedron relative to the base.

The disclosed three-dimensional calibration target may utilize a home position indicator which indicates a predefined angular position of the asymmetric polyhedron relative to its base. In one implementation, the calibration target may comprise a motorized actuator to rotate the asymmetric polyhedron from a home position to various predefined angular positions. In yet other implementations, the calibration target may be rotatably supported so as to be manually rotated from an indicated home position to various predefined angular positions.

Disclosed is an example method that may include rotating an asymmetric polyhedron relative to a base supporting the asymmetric polyhedron between predefined angular positions, capturing images of the asymmetric polyhedron at the predefined angular positions with differently positioned cameras, detecting two-dimensional features in the images at the predefined angular positions, merging the two-dimensional features and corresponding 3-D coordinates using a single object coordinate of the asymmetric polyhedron and calibrating or validating camera to camera alignment based upon the merging of the two-dimensional features from the different angular positions using a single reference frame which defines the single object coordinate.

Disclosed is an example three-dimensional scanning system that may include cameras and a three-dimensional calibration target. The three-dimensional calibration target may include an asymmetric polyhedron having a bottom and at least four faces, a base underlying the bottom and rotatably supporting the asymmetric polyhedron and a home position indicator to indicate a predefined angular position of the asymmetric polyhedron relative to the base.

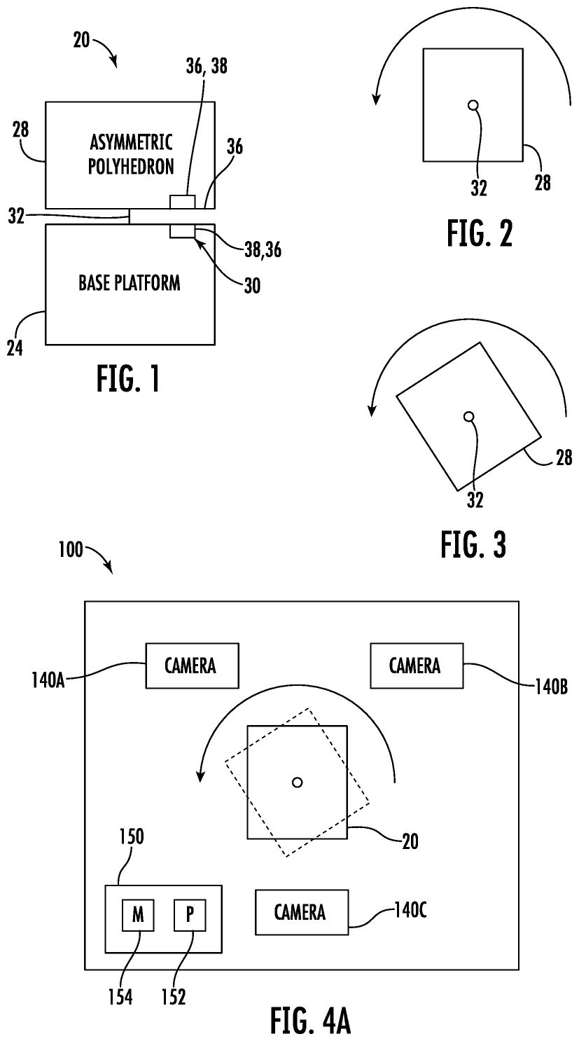

FIG. 1 schematically illustrates portions of an example three-dimensional calibration target 20. Calibration target 20 facilitates more reliable and less complex calibration of multiple cameras. Calibration target 20 is multipurpose in that it facilitates calibration, calibration verification and scan quality validation. Calibration target 20 comprises base platform 24, asymmetric polyhedron 28 and home position indicator 30.

Base platform 24 supports asymmetric polyhedron 28. In one implementation, base platform 24 underlies asymmetric polyhedron 28 and extend outwardly beyond the outer perimeter of asymmetric polyhedron 28. In another implementation, base platform 24 underlies asymmetric polyhedron 28, being recessed from the sides of asymmetric polyhedron 28. In implementations where base platform 24 is recessed such that no visible turntable mechanism or cables are present, calibration performance may be enhanced. In one implementation, base platform 24 is at least partially received within underlying cavity of asymmetric polyhedron 28, projecting beyond the lower surface of asymmetric polyhedron 28 to elevate asymmetric polyhedron 28 above a support surface. In one implementation, base platform 24 may elevate the bottom of asymmetric polyhedron 28 by 5 mm.

As shown by FIGS. 2 and 3, base platform 24 rotatably supports asymmetric polyhedron 28 for rotation about an axis 32. In one implementation, base platform 24 rotatably supports asymmetric polyhedron 28 through complete 360° rotation about axis 32. In another implementation, base platform 24 rotatably supports asymmetric polyhedron 28 through angles less than 360°. In one implementation, base platform 24 comprises a spindle extending along axis 32 and about which asymmetric polyhedron 28 rotates. In another implementation, base platform 24 comprises a cylindrical cavity which receives a spindle or hub projecting from asymmetric polyhedron 28 along axis 32.

Asymmetric polyhedron 28 comprises an asymmetric body having a bottom 36 and at least four upwardly facing or upwardly inclined faces. The faces extend at different angles relative to one another such that the body is asymmetric with respect to axis 32. Adjacent faces are separated by a mutually shared edge.

Home position indicator 30 indicates a predefined angular position of asymmetric polyhedron 28 relative to base platform 24. Home position indicator 30 facilitates predefined angular positions of asymmetric polyhedron 28 as asymmetric polyhedron 28 is rotated between different angular positions 140 during calibration. In one implementation, home position indicator 30 comprises an inductive sensor, wherein one of base platform 24 and asymmetric polyhedron 20 comprises a marker 36 while the other of base platform 24 and asymmetric polyhedron 28 comprises a sensor 38 that senses a proximity of the marker to indicate a home position. In one implementation, the marker may comprise an optical feature, wherein the sensor comprises an optical sensor. In another implementation, the marker may comprise a metal surrounded by non-metallic or insulative material, wherein the sensor comprises an inductor having an impedance that changes based upon the proximity of the metal material of the marker. In yet other implementations, home position indicator 30 may have other forms.

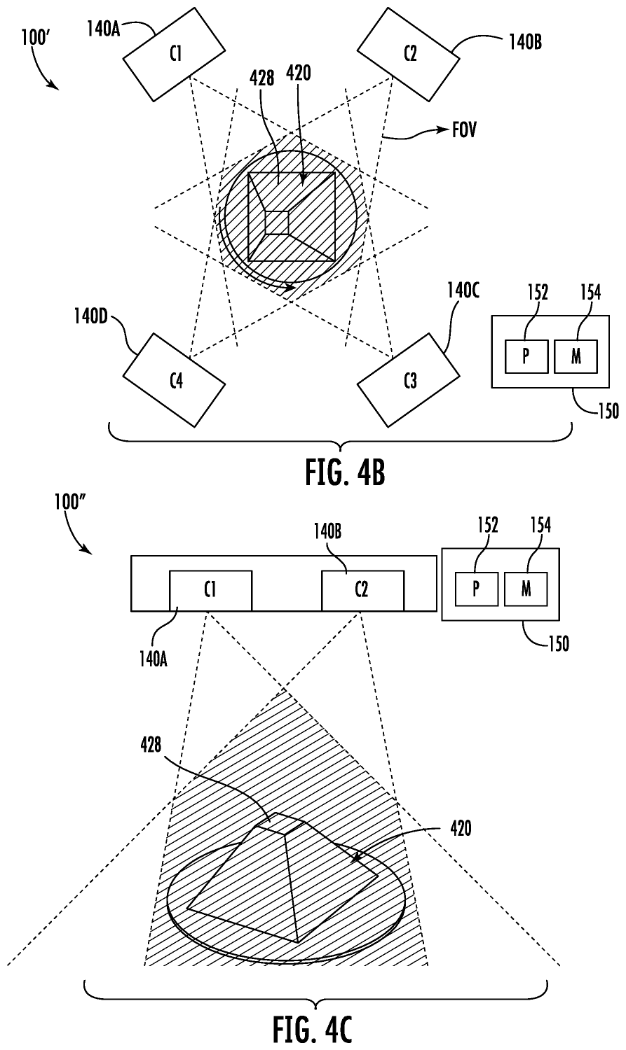

FIG. 4A schematically illustrates portions of an example three-dimensional scanning system 100. Three-dimensional scanning system 100 utilizes calibration target 20 described above. In addition to calibration target 20, scanning system 120 comprises cameras 140A, 140B and 140C (collectively referred to as cameras 140) and calibrator 150. Cameras 140 are positioned at different positions about calibration target 20. Cameras 140 cooperate to capture three-dimensional data for an object being scanned as well as three-dimensional data for the asymmetric polyhedron 28 of calibration target 20. In one implementation, cameras 140 comprise different types of cameras. For example, in one implementation, one of cameras 140 may comprise an infrared camera, another of cameras 140 may comprise a depth camera (e.g., an infrared projector, a time-of-flight sensor, etc.), and yet another one of cameras 140 may comprise a red-green-blue (RGB) camera (a color camera). In some implementations, system 100 may include multiple infrared cameras, multiple depth cameras and multiple RGB cameras in combination. In some implementations, system 100 may comprise a greater number of cameras at different positions about the object or calibration target 20 being scanned.

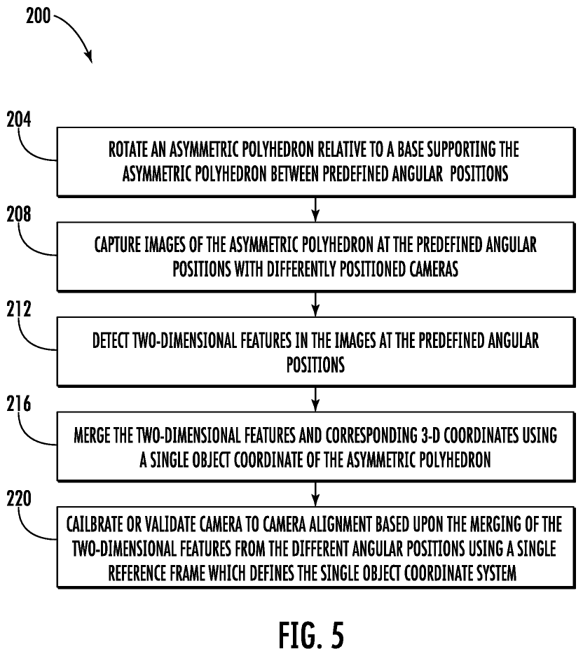

Calibrator 150 is in communication with each of cameras 140. Calibrator 150 may communicate with cameras 140 in a wired or wireless fashion. In the example illustrated, calibrator 150 comprises a processing unit 152 that follows instructions provided by a non-transitory computer-readable medium 154. Processing unit 152, following instructions provided in medium 154, performs three-dimensional camera alignment based upon signals received from the cameras and the determined angular positioning of asymmetric polyhedron 28 about axis 32. In one implementation, the angular positioning of asymmetric polyhedron 28 about axis 32 is determined based upon signals received from the target 20, such as signals from the home position indicator which senses the angle or offset of asymmetric polyhedron 20 relative to the home position. In another implementation, the angular positioning of asymmetric polyhedron 28 about axis 32 is determined based upon the direct instruction or input from a motor control signal (for example as a command of embedded software) to drive the motor actuator precisely. In another implementation, the person may be prompted on a display screen or otherwise to rotate polyhedron 28 between various predefined angular positions and to indicate to calibrator 150 when the asymmetric polyhedron 28 has been positioned in the different angular positions about axis 32. In one implementation, calibrator 150 may perform such calibration/validation by carrying out method 200 described below with respect to FIG. 5.

FIG. 4B is a top view of another example three-dimensional scanning system 100′. Scanning system 100′ is similar to scanning system 100 except the scanning system 100′ is illustrated as being utilized with an example target 420 (shown and described in more detail hereafter with respect to FIGS. 7-11) and that scanning system 100′ comprises cameras 140A, 140B, 140C and 140D (collectively referred to as cameras 140) organized around target 420 with equal angular separation. As shown by broken lines, portions of the field of view of the different neighboring cameras 140 overlap one another.

Cameras 140 cooperate to capture three-dimensional data for an object being scanned as well as three-dimensional data for the asymmetric polyhedron 428 of calibration target 420. In one implementation, cameras 140 comprise different types of cameras. For example, in one implementation, one of cameras 140 may comprise an infrared camera, another of cameras 140 may comprise a depth camera (e.g., an infrared projector, a time-of-flight sensor, etc.), and yet another one of cameras 140 may comprise a red-green-blue (RGB) camera (a color camera). In some implementations, system 100′ may include multiple infrared cameras, multiple depth cameras and multiple RGB cameras in combination. As a system 100, calibrator 150 may perform such calibration/validation by carrying out method 200 described below with respect to FIG. 5.

FIG. 4C is a perspective view of another example three-dimensional scanning system 100″. Scanning system 100″ is similar to scanning system 100′ except the scanning system 100″ is illustrated as being utilized with an example target 420 (shown and described in more detail hereafter with respect to FIGS. 7-11) and that scanning system 100″ comprises cameras 140A, 140B′ (collectively referred to as cameras 140) organized around target 420 with equal angular separation. In contrast to the arrangement of cameras 140 in system 100′, the arrangement of cameras 140 in system 100″ has a smaller baseline separation, wherein a 360° angle view of the object is obtained through the rotation of target 420. As shown by broken lines, portions of the field of view of the different neighboring cameras 140 overlap one another.

Cameras 140 cooperate to capture three-dimensional data for an object being scanned as well as three-dimensional data for the asymmetric polyhedron 428 of calibration target 420. In one implementation, cameras 140 comprise different types of cameras. In one implementation, cameras 140 comprise a depth camera and a pair of RGB sensors separated by such a small baseline. In other implementations, additional cameras (also referred to as sensors) may be utilized. For example, in other implementations, one of cameras 140 may comprise an infrared camera, another of cameras 140 may comprise a depth camera (e.g., an infrared projector, a time-of-flight sensor, etc.), and yet another one of cameras 140 may comprise a red-green-blue (RGB) camera (a color camera). In some implementations, system 100″ may include multiple infrared cameras, multiple depth cameras and multiple RGB cameras in combination. As a system 100, calibrator 150 may perform such calibration/validation by carrying out method 200 described below with respect to FIG. 5.

FIG. 5 is a flow diagram of an example three-dimensional multi-camera calibration method 200. Method 200 facilitates more reliable and less complex calibration of multiple cameras. Although method 200 is described in the context of being carried out by system 100, it should be appreciated that method 200 may likewise be carried out with any of the systems described hereafter utilizing calibration target 20 or with similar systems using similar calibration targets.

As indicated by block 204, an asymmetric polyhedron, such as asymmetric polyhedron 28, is rotated relative to a base, such as base platform 24, supporting asymmetric polyhedron between predefined angular positions. As indicated by block 208, at each of the predefined angular positions, differently position cameras, such as cameras 140, capture images of the asymmetric polyhedron. In one implementation, the asymmetric polyhedron may be manually rotated between the predefined angular positions. In another implementation come asymmetric polyhedron may be rotated between the different predefined angular positions by a rotary actuator.

As indicated by block 212, two-dimensional features in the images at each of the predefined angular positions are detected. For example, in one implementation, calibrator 150 receives signals from the different cameras 140 corresponding to the images taken by the different cameras 140 at the different predefined angular positions. Calibrator 150 detects or identifies two-dimensional features, such as the edges of the different faces of the asymmetric polyhedron 28 at each of the different predefined angular positions.

As indicated by block 216, a single object coordinate system of the asymmetric polyhedron is used to identify three-dimensional coordinates. The three-dimensional coordinates and the corresponding two-dimensional features detected in the images are combined by calibrator into a single object pose. In particular, in one implementation, the single object coordinate with its origin corresponds to the intersection of axis 32 of asymmetric polyhedron 28 and the base plane.

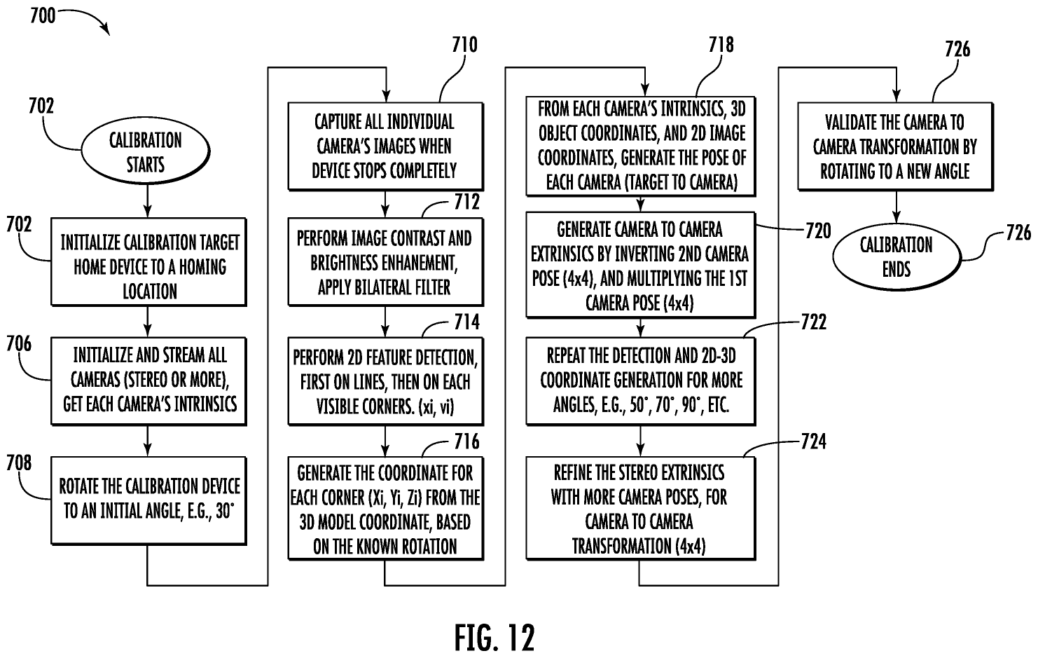

As indicated by block 220, calibrator 150 calibrates and/or validates camera to camera alignment based upon the merging of the two-dimensional features and three-dimensional object corner coordinates from the different angular positions using a single reference frame which defines the single object coordinate. In one implementation, “merge” refers to the combining of multiple object poses captured by a camera at different locations/angles, the combining of all 2D features and the corresponding 3D coordinates by the calibrator to solve the camera to a single object pose. Such merging involving the combining of the 3D object coordinates at different angles (corresponding the detected 2D features for a camera) is due to the single object coordinate system/common origin as discussed above with respect to block 216. One example of such merging is set forth below with respect to FIG. 12 and method 700. Thereafter, the three-dimensional data regarding a scanned object is gathered using the calibration (camera to camera alignment) of the multiple cameras.

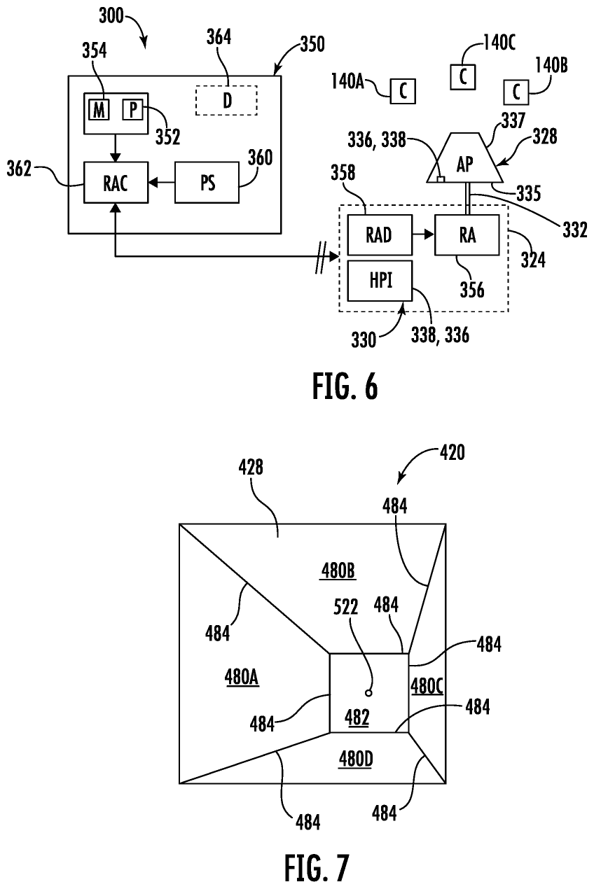

FIG. 6 schematically illustrates an example three-dimensional scanning system 300 scanning system 300 facilitates more reliable and less complex calibration of multiple cameras. Scanning system 300 utilizes a rotary actuator to rotate an asymmetric polyhedron between predefined different angular positions at which images are captured by multiple cameras. Scanning system 300 may utilize a calibration target for each of calibration, calibration verification and scan quality validation. Scanning system 300 comprises calibration target 320, cameras 140 (described above) and calibrator 350.

Calibration target 320 comprises base platform 324, asymmetric polyhedron 328 and home position indicator 330. Base platform 324 is similar to base platform 24 described above in that base platform rotatably supports asymmetric polyhedron 328 about an axis 332. In the example illustrated, base platform 324 rotatably drives asymmetric polyhedron 328 about axis 332 in response to control signals received from calibrator 350. In the example illustrated, base platform 324 comprises a rotary actuator 356 and a rotary actuator driver 58. Rotary actuator 356 may comprise a motor or other drive a rotating asymmetric polyhedron 328 about axis 332 in a controlled fashion between different angular positions. In some implementations, rotary actuator 356 stops the rotation of asymmetric polyhedron 328 at each of the predefined angular positions. In one implementation, rotary actuator 356 may comprise a stepper motor to achieve precise positioning via digital control. Rotary actuator driver 358 outputs signals controlling rotary actuator 356 in response to control signals received from calibrator 350.

Asymmetric polyhedron 328 is similar to asymmetric polyhedron 28 described above. Asymmetric polyhedron 328 comprises an asymmetric body having a bottom 335 and at least four upwardly facing or upwardly inclined faces 337. The faces extend at different angles relative to one another such that the body is asymmetric with respect to axis 32. Adjacent faces 337 are separated by a mutually shared edge.

Home position indicator 330 indicates a predefined angular position of asymmetric polyhedron 328 relative to base platform 324. Home position indicator 330 facilitates predefined angular positions of asymmetric polyhedron 328 as asymmetric polyhedron 328 is rotated between different angular positions during calibration. In one implementation, home position indicator 330 comprises an inductive sensor, wherein one of base platform 324 and asymmetric polyhedron 320 comprises a marker 336 while the other of base platform 324 and asymmetric polyhedron 328 comprises a sensor 338 that senses a proximity of the marker to indicate a home position. In one implementation, the marker may comprise an optical feature, wherein the sensor comprises an optical sensor. In another implementation, the marker may comprise a metal surrounded by non-metallic or insulative material, wherein the sensor comprises an inductor having an impedance that changes based upon the proximity of the metal material of the marker. In yet other implementations, home position indicator 30 may have other forms.

Cameras 140 cooperate to capture three-dimensional images of asymmetric polyhedron 328. Cameras 140 may be arranged as described above in FIG. 4A, FIG. 4B or FIG. 4C as described above. Although three of such cameras 140 are illustrated, it should be appreciated that system 300 may comprise multiple combinations of cameras. In one implementation, cameras 140 comprise a depth camera and a pair of RGB sensors separated by such a small baseline. In other implementations, additional cameras (also referred to as sensors) may be utilized. For example, in other implementations, one of cameras 140 may comprise an infrared camera, another of cameras 140 may comprise a depth camera (e.g., an infrared projector, a time-of-flight sensor, etc.), and yet another one of cameras 140 may comprise a red-green-blue (RGB) camera (a color camera). In some implementations, system 300 may include multiple infrared cameras, multiple depth cameras and multiple RGB cameras in combination.

Calibrator 350 is similar to calibrator 50 described above. Calibrator 350 is in communication with each of cameras 140. Calibrator 350 is additionally in communication with calibration target 320. Calibrator 150 may communicate with cameras 140 and/or calibration target 320 in a wired or wireless fashion.

In the example illustrated, calibrator 350 comprises a processing unit 352 that follows instructions provided by a non-transitory computer-readable medium 354. Processing unit 352, following instructions provided in medium 354, performs three-dimensional camera alignment based upon signals received from the cameras and the angular positioning of asymmetric polyhedron 328 about axis 332.

In the illustrated example, calibrator 350 controls the angular positioning of asymmetric polyhedron 328 about axis 332. In one implementation, calibrator 350 outputs control signals to calibration target 320 to control the positioning of asymmetric polyhedron 328 relative to base 324. In the example illustrated, calibrator 350 comprises a rotary actuator power source 360 and rotary actuator controller 362. Power source 360 provides power to rotary actuator controller 360. Rotary actuator controller 360 outputs signals which are transmitted to rotary actuator driver 358. In one implementation, power source 360 comprises the DC power source while rotary actuator controller 362 comprises a stepper controller. In other implementations, power source 360 and rotary actuator controller 362 may have other forms.

When calibrating cameras 140 or verifying the alignment or calibration of cameras 140, calibrator 350 may initially output control signals rotating asymmetric polyhedron 328 to an initial home or default position relative to base 324. In another implementation, calibrator 350 may output control signals to a display 364 (shown in broken lines) causing the display 364 to prompt the user to manually position asymmetric polyhedron 328 in initial home position. Thereafter, upon confirming the positioning of asymmetric polyhedron 328 in the home position, calibrator 350 may output control signals causing rotary actuator 356 to rotate asymmetric polyhedron 328 to each of multiple predefined angular positions.

As described above with respect to method 200, at each of the different predefined angular positions, calibrator 350 may output signals causing cameras 140 to capture images of asymmetric polyhedron 328. Upon receiving signals from cameras 140, calibrator 350 may identify or detect two-dimensional features in the images at each of the predefined angular positions. For example, in one implementation, calibrator 350 receives signals from the different cameras 140 corresponding to the images taken by the different cameras 140 at the different predefined angular positions. Calibrator 350 detects or identifies two-dimensional features, such as the edges of the different faces of the asymmetric polyhedron 328 at each of the different predefined angular positions.

Once the two-dimensional features of the different faces of asymmetric polyhedron 328 are identified by calibrator 350, calibrator 350 merges the two-dimensional features with the corresponding three-dimensional coordinates which are based upon a single object coordinate of the asymmetric polyhedron 328.

In one implementation, the single object coordinate system corresponds to axis 332 of asymmetric polyhedron 328. Based upon the merging of the two-dimensional features from the different angular positions using a single reference frame which defines a single object coordinate, calibrator 350 calibrates and/or validates camera to camera alignment. Thereafter, the three-dimensional data regarding a scanned object is gathered using the calibration of the multiple cameras 140.

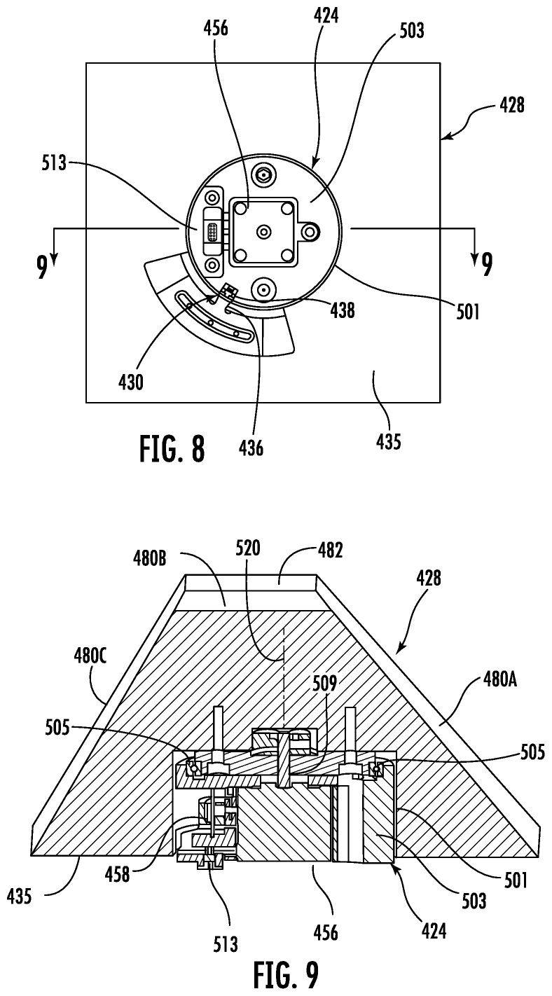

FIGS. 7-9 illustrate an example calibration target 420 which may be utilized as part of system 300 in place of target 320. Calibration target 420 comprises base platform 424, asymmetric polyhedron 428 and home position indicator 430. As shown by FIGS. 8 and 9, base platform 424 elevates and rotatably supports asymmetric polyhedron 428. In one implementation, base platform 424 elevates asymmetric polyhedron 428 by at least 2 mm and no greater than 10 mm, and nominally 5 mm. Base platform 424 comprises rotary actuator 456 and rotary actuator driver 458. Rotary actuator 456 and rotary drive 458 are received within an internal cavity 501 formed in an underside of asymmetric polyhedron 428. Rotary actuator 456 and rotary actuator driver 458 are mounted to a block 503 which rotatably supports asymmetric polyhedron 428 with bearings 505.

Rotary actuator 456 comprises a motor having an output shaft 509 connected to asymmetric polyhedron 428 such that rotation of shaft 509 by rotary actuator 456 rotate asymmetric polyhedron 428 relative to and about cavity 501 and about block 503. Rotary actuator driver 458 comprises a circuit board with control electronics supported by block 503 within cavity 501. In the example illustrated, rotary actuator driver 458 communicates with an external calibrator, such as calibrator 350 described above, via a wired connection port 513. In other implementations, rotary actuator driver 458 may comprise a wireless transmitter for wirelessly communicating with calibrator 350.

Asymmetric polyhedron 428 is similar to asymmetric polyhedron 28 described above. Asymmetric polyhedron 428 comprises a body that is asymmetric with respect to rotational axis 520 and that is also asymmetric with respect to a model or object coordinate 522 which extends perpendicular to surface 482 equidistant from each of the four edges of surface 482. Asymmetric polyhedron 428 comprises bottom 435 (shown in FIGS. 8 and 9), at least four upwardly facing or upwardly inclined faces 480A, 480B, 480C and 480D (collectively referred to as faces 480) and top surface 482. The faces 480 extend at different angles relative to one another and are separated by mutually shared edges 484.

In the example illustrated, each of such faces 480 extends at an angle of at least 30° and no greater than 70° with respect to a horizontal plane such as surface 482. Each adjacent pair of faces 480 has an angle resolution for separation of at least 5°. The base 435 is sized to occupy at least 40%, and in one implementation, at least 50% of a field of view of the calibrated cameras 140.

In the example illustrated, each of faces 480 is provided with an optical feature, different than the optic features of the adjacent faces and which extends completely to the edges of such face. As a result, the optical feature assists in the identification of edges 484 extending between faces 480. Examples of optical features, which may be optically detected and distinguished from one another in the images captured by cameras 140 include, but are not limited to, different colors, different textures and different patterns. In the example illustrated, faces 480 are provided with different solid colors that span an optical color space such as LAB or YCrCb. As a result, faces 480 additionally facilitate checking or confirming the accuracy of color overlay on a three-dimensional mesh on both calibration and scan quality. Such colors provide a robust detection and correction of errors in the calibration process.

In one example implementation, face 480A is oriented at 45° with respect to the horizontal and is provided with a light green color (366U). Surface 480B is oriented 60° with respect to the horizontal and provided with a light maroon (1215U). Surface 480C is oriented at 70° with respect to the horizontal and is provided with a light yellow/orange color (1215U). Surface 480D is oriented at 50° with respect to the horizontal and is provided with a light blue color (283U). Surface 482 is at 0° with respect the horizontal, being horizontal, and provided with a cool gray or light gray color (2U). In other implementations, faces 480 may be provided at other different angles and may provide with different optical features, whether different colors, whether different textures, whether different patterns or combinations thereof.

Home position indicator 430 indicates the angular rotation of asymmetric polyhedron 428 about rotational axis 520 and further indicates when asymmetric polyhedron 428 is residing in a default or home angular position about axis 520. In the example illustrated, home position indicator 430 comprises a marker 436 affixed or formed as part of the body of asymmetric polyhedron 428 and a sensor 438 carried by the block 503 of base platform 424. The marker 436 and the sensor 438 cooperate to indicate the angular positioning of asymmetric polyhedron 428 relative to base platform 424. In the example illustrated, marker 436 comprises metal projection while sensor 438 comprises an inductive sensor 438 having an electromagnetic field that changes in response to proximity of the inductive sensor 438 relative to marker 436. In other implementations, the marker 436 may comprise an optical marker, such as an optical emitter, wherein sensor 436 comprises an optical detector. In other implementations, the marker 436 may comprise a resilient flexible protuberance while the sensor 438 comprises a detent, wherein the sensor 438 outputs an electrical signal in response to the protuberance projecting into or being received by the detent. In still other implementations, the marker 436 and sensor 438 may comprise other interacting positional sensing devices. Moreover, in other implementations, the location of marker 436 and sensor 438 may be reversed, wherein marker 436 is carried by platform 424 and wherein sensor 438 is carried by asymmetric polyhedron 428.

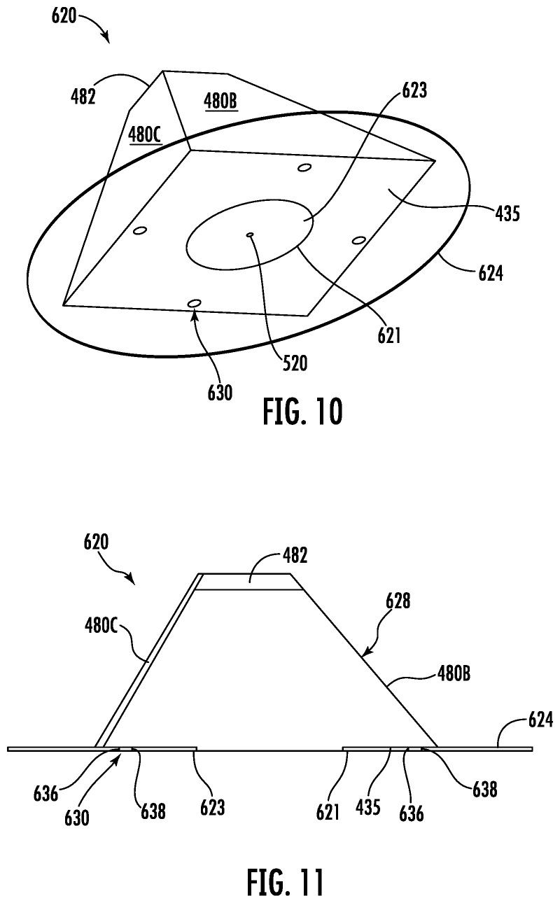

FIGS. 10 and 11 illustrate an example calibration target 620 which may be utilized as part of system 300 in place of target 320. Calibration target 620 is similar to calibration target 420 except that calibration target 620 is to be manually rotated between predefined angular positions relative to a base. Calibration target 520 comprises base platform 624, asymmetric polyhedron 628 and home position indicator 630.

Base platform 624 comprises a mat or pad underlying asymmetric polyhedron 628 and extending outwardly beyond the perimeter of asymmetric polyhedron 628. Unlike base platform 424, base platform 624 omits a rotary actuator or a rotary actuator driver. In contrast, base platform 624 comprises a circular opening, recess or detent 621 which receives a portion of asymmetric polyhedron 628 to guide manual rotation of asymmetric polyhedron 628.

Asymmetric polyhedron 628 is similar to asymmetric polyhedron 428. Like asymmetric polyhedron 428, asymmetric polyhedron 628 comprises bases 480 and surface 482 as described above. Unlike asymmetric polyhedron 428, asymmetric polyhedron 628 omits cavity 501 and comprises a hub 623 slidably received within detent 621. In other implementations, the relationship between detent 621 and hub 623 may be reversed. For example, in other implementations, base platform 621 may comprise an upwardly projecting hub while asymmetric polyhedron 62 a comprises an upwardly projecting detent or cavity that slidably receives the upwardly projecting hub, facilitating rotation of asymmetric polyhedron 628 relative to base platform 624.

Home position indicator 630 is formed by cooperating elements of platform 624 and asymmetric polyhedron 628. In one implementation, home position indicator 630 provides a tactile indication of angular alignment of asymmetric polyhedron 628 with respect to a home or default angular position or state. In the example illustrated, home position indicator 630 is provided by angularly spaced detents 636 formed in platform 624 which removably receive downwardly projecting protuberances 638 extending from bottom 435 of asymmetric polyhedron 628. At least one of the sidewalls of detents 636 and protuberance 638 is resiliently flexible and deformable to facilitate withdrawal of protuberances 638 from detents 636 in response to asymmetric polyhedron 628 being manually rotated relative to platform 624. During such rotation and when brought into alignment, protuberances 638 snap or pop into detents 636, providing a tactile indication of the orientation of asymmetric polyhedron 628. Although home position indicator 630 is illustrated as comprising four pairs of detents 636, protuberances 638 spaced 90° about the rotational axis 520 of asymmetric polyhedron 628, in other implementations, home position indicator 630 may comprise a fewer or greater of such detent-protuberance pairs and may include such detent-protuberance pairs at other angular spacings. In some implementations, an upper surface of platform 624 may be provided with an arrow, mark or other indicia for alignment with a corresponding arrow, mark or other indicia provided on one of faces 480 to indicate a home angular position of asymmetric polyhedron 428 with respect to platform 624.

In one implementation, the user may be prompted on display 364 (shown in FIG. 6 by calibrator 350) or by other sources of calibration instructions to manually rotate asymmetric polyhedron 628 between multiple predefined angular positions and to provide input to calibrator 350 when asymmetric polyhedron 628 is in the angular position as directed by such instructions. In yet other implementations, although asymmetric polyhedron 628 is manually rotated relative to platform 624, calibration target 620 may comprise a home position indicator, such as home position indicator 30 or 430 as described above. In such an implementation, calibrator 350 may automatically sense when asymmetric polyhedron 628 has been rotated to one of the predefined angular positions at which cameras 140 are to capture images for calibration/validation.

FIG. 12 is a flow diagram of an example three-dimensional multi-camera calibration/validation method 700. Method 700 facilitate more reliable and less complex calibration of multiple two-dimensional cameras for three-dimensional scanning. Although method 700 is described in the context of being carried out by system 300 utilizing calibration target 420, it should be appreciated that method 700 may likewise be carried out with any of the described scanning systems utilizing any of the described calibration targets or using similar calibration targets.

As indicated by block 702, calibration is initiated or started. Such calibration may be initiated by user entering an appropriate selection or command to calibrator 350 through an input, such as through a touchscreen input provided by display 364. As indicated by block 704, upon receiving such a calibration initiation command, calibrator 350 may initialize the calibration target, outputting control signals causing rotary actuator 456 to rotate asymmetric polyhedron 428 to an initial home or homing location. In one implementation, calibrator 350 outputs control signals to rotary actuator 456 causing rotation of asymmetric polyhedron 428 until calibrator 350 receives signals from home position indicator 430 that asymmetric polyhedron 428 is at the initial or default angular position. As further indicated by block 706, prior to such calibration, calibrator 350 may initialize and stream all of cameras 140 to obtain each cameras intrinsics.

As indicated by block 708, calibrator 350 outputs control signals causing rotary actuator 456 to rotate asymmetric polyhedron 428 to an initial predefined angular position such as 30° from the home position. As indicated by block 710, while asymmetric polyhedron 428 is stationary at the first predefined angular calibration position, cameras 140 capture images which are transmitted to calibrator 350. As indicated by block 712, following instructions contained in medium 354, processor 352 performs image contrast and brightness enhancement, may apply a bilateral filter to such images to further remove image noise.

As indicated by block 714, processor 352, following instructions contained in memory 354 (shown in FIG. 6) performs two-dimensional feature detection, first on the lines/edges 480 and then on each visible corner. Such feature detection involves an identification of two-dimensional coordinates (xi, yi) for the corners from line intersections.

As indicated by block 716, processor 352, following instructions contained in medium 354, generates three-dimensional object coordinates (Xi, Yi, Zi) for each corner from the three-dimensional model coordinate 522 (shown in FIG. 7) based upon the particular predefined angular orientation of asymmetric polyhedron 428. As indicated by block 718, from each camera's intrinsics, determined three-dimensional object coordinates (determined in block 716) and the two-dimensional feature coordinates (determined in block 714), processor 352, following instructions contained in medium 354, generates a pose of each of cameras 140 (relative positioning of the asymmetric polyhedron 428 relative to the individual cameras 140).

As indicated by block 720, calibrator 350 generates camera to camera extrinsics (the relative positions and orientations of one camera to another camera) by inverting the pose generated for a first one of cameras 140 in block 718 at a particular predefined angular position of asymmetric polyhedron 428 and multiplying the inverted pose by the generated pose for a second one of cameras 140 in block 718 at the predefined angular position of asymmetric polyhedron 428.

As indicated by blocks 722 and 724, calibrator 350 repeatedly carries out blocks 708-720 for multiple predefined different angular positions of asymmetric polyhedron 428, generating two-dimensional and three-dimensional coordinates and further refining stereo extrinsics-camera to camera extrinsics using additional camera poses. As indicated by block 726, calibrator 350 validates the camera to camera transformation/extrinsics by outputting control signals causing rotary actuator 456 to rotate asymmetric polyhedron 428 to a new predefined angular position. As indicated by block 728, upon such validation, the calibration process may be terminated.

According to one example calibration protocol, scanning system 300 may comprise n cameras mounted in a 360° multi-view arrangement for a total of n−1 stereo pairs between neighboring cameras. For example, camera 1 to camera 2, camera 2 to camera 3, . . . camera n−1 to camera n. During scanning system calibration, from a homing position of angle 0°, calibrator 350 may rotate asymmetric polyhedron smoothly to angle 10°, 20°, 30°, 40°, 50°, 60°. During such travel, six image captures are obtained from each camera, with one image captured every 10°. For each of the cameras, four lines and four intersection corners may be detected in every 10° capture. Each of the corners are recorded in the local world three-dimensional coordinate, generated from the rotational angle and design geometry of the asymmetric polyhedron. Corner positions determined in the image two-dimensional coordinates may also be recorded. For each camera, the total number of 24 (4×6) or more of two-dimensional and three-dimensional corners are found with identification from the unique color of planes images and corresponding surface angle.

Thereafter, calibrator 350 may merge the two-dimensional coordinates and three-dimensional coordinates for each camera, and solve the camera pose with known camera intrinsics using nonlinear optimization. Calibrator 350 may then solve calibration extrinsic parameters between the two neighbor cameras from the calculated poses of individual cameras relative to the asymmetric polyhedron, which are expressed in a 3×3 rotational matrix, and a 1×3 translational vector; this is repeated for n−1 pairs of cameras.

To provide calibration verification between color and depth sensing cameras, the following protocol may be carried out. Calibrator 350 may output control signals causing rotary actuator 456 to rotate asymmetric polyhedron 428 clockwise from home position 0° to each angle of verification, for example, 90°, 180°, 270° and 360°. When the asymmetric polyhedron 428 is still at each ‘verification’ angle, e.g., 90°, the depth camera scans to get a (X,Y,Z) vertices map for a three-dimensional point cloud of the asymmetric polyhedron. The color camera captures a two-dimensional image of the same verification angle. Calibrator 350 performs the plane segmentation from the three-dimensional point cloud to extract the individual faces, each surface with a plane function in the camera three-dimensional coordinates. Calibrator 350 further extracts three-dimensional lines from neighboring faces. With respect to the two-dimensional color images, calibrator 350 may identify lines that belong to the asymmetric polyhedron and de-project (convert) the selected two-dimensional line(s) to three-dimensional camera coordinates with camera intrinsics and extrinsics and color-registered depth which was transformed from depth camera coordinates to the color camera coordinates using the stereo calibration parameters. Calibrator 350 may further calculate the offset between the set of three-dimensional lines reconstructed from the color image and the lines found in the three-dimensional point cloud. Calibrator 350 may validate the offset in three-dimensional camera coordinates between the pair of three-dimensional line(s). This validation process may be repeated for 180°, 270° and 360° to generate an alignment offset map which is to qualify the stereo calibration between the color and depth sensing cameras.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A three-dimensional calibration target comprising:
an asymmetric polyhedron having a bottom and at least four faces;
a base platform underlying the bottom and rotatably supporting the asymmetric polyhedron; and
a home position indicator to indicate a predefined angular position of the asymmetric polyhedron relative to the base platform.

2. The three-dimensional calibration target of claim 1, wherein the at least four faces comprise a first face and a second face separated by an edge, wherein the first face has a first optical feature extending to the edge and wherein the second face has a second optical feature, different than the first optical feature, extending to the edge.

3. The three-dimensional calibration target of claim 1, wherein the first optical feature comprises a first color and wherein the second optical feature comprises a second color different than the first color.

4. The three-dimensional calibration target of claim 1, wherein the at least four faces each have an angle of at least 30° and no greater than 70° with respect to a horizontal plane, wherein adjacent surfaces have angle differences of at least 5°.

5. The three-dimensional calibration target of claim 4 further comprising a top surface opposite the bottom.

6. The three-dimensional calibration target of claim 5, wherein the top surface is a neutral color.

7. The three-dimensional calibration target of claim 1, wherein the home position indicator comprises:
a detent in one of the base in the asymmetric polyhedron; and
a protuberance projecting from the other of the base in the asymmetric polyhedron such that relative rotation of the base in the asymmetric polyhedron moves the protuberance into and out of the detent.

8. The three-dimensional calibration target of claim 1, wherein the home position indicator comprises:
a marker in one of the base in the asymmetric polyhedron; and
a sensor in the other of the base and the asymmetric polyhedron, wherein the sensor is to sense proximity of the marker to indicate the home position.

9. The three-dimensional calibration target of claim 7 further comprising:
a motor to rotate the asymmetric polyhedron relative to the base; and
a controller to control signals controlling the motor to rotate the asymmetric polyhedron between poses, the control signals being based upon a sensed position of the asymmetric polyhedron relative to the base.

10. A method comprising:
rotating an asymmetric polyhedron relative to a base supporting the asymmetric polyhedron between predefined angular positions;
capturing images of the asymmetric polyhedron at the predefined angular positions with differently positioned cameras;
detecting two-dimensional features in the images at the predefined angular positions;
merging the two-dimensional features and corresponding three-dimensional coordinates using a single object coordinate of the asymmetric polyhedron; and
calibrating or validating camera to camera alignment based upon the merging of the two-dimensional features from the different angular positions using a single reference frame which defines the single object coordinate.

11. The method of claim 10, wherein further comprising rotating the asymmetric polyhedron calibration target relative to a base to a home location prior to rotating the asymmetric polyhedron between the predefined angular positions.

12. The method of claim 10, wherein the calibrating or validating of camera to camera alignment comprises, for each of the predefined angular positions:
detecting edges between adjacent faces of the asymmetric polyhedron calibration target from the images;
detecting corners of the asymmetric polyhedron calibration target from the images;
generating three dimensional coordinates for each corner based upon a defined object coordinate of the asymmetric polyhedron calibration target and an angular position of the asymmetric polyhedron calibration target for the respective image;
generating a camera pose for each camera based upon each cameras intrinsics, the object coordinates of the asymmetric polyhedron and the generated two-dimensional coordinates;
generating first camera to a second camera extrinsics by multiplying an inversion of a camera pose for the first camera by a camera pose for the second camera.

13. A three-dimensional scanning system comprising:
cameras;
a three-dimensional calibration target comprising:
an asymmetric polyhedron having a bottom and at least four faces;
a base underlying the bottom and rotatably supporting the asymmetric polyhedron; and
a home position indicator to indicate a predefined angular position of the asymmetric polyhedron relative to the base; and
a calibrator in communication with each of the cameras and the three-dimensional calibration target, wherein the calibrator is to perform three-dimensional camera alignment based upon signals received from the cameras.

14. The system of claim 13, wherein the cameras comprise:
an infrared camera;
a depth camera; and
an RGB camera.

15. The system of claim 13, wherein the at least four faces comprise a first face and a second face separated by an edge, wherein the first face has a first optical feature extending to the edge and wherein the second face has a second optical feature, different from the first optical feature, the first optical feature extending to the edge and wherein the at least four faces each have a different angle of at least 30° and no greater than 70° with respect to a horizontal plane, wherein the asymmetric polyhedron further comprises a top surface opposite the bottom, the top surface having being neutral color.
